(19) United States
(12) Patent Application Publication
(10) Pub. No.: US 2014/0267920 A1
(43) Pub. Date: Sep. 18, 2014

(54) RECEIVING APPARATUS AND RECEIVING METHOD

(71) Applicant: Sony Corporation, Tokyo (JP)

(72) Inventor: Tomonori NAKAJIMA, Tokyo (JP)

(73) Assignee: Sony Corporation, Tokyo (JP)

(21) Appl. No.: 14/196,174

(22) Filed: Mar. 4, 2014

(30) Foreign Application Priority Data
Mar. 18, 2013 (JP) 2013-054937

(51) Int. Cl. H04N 5/50; H04N 5/21

(52) U.S. Cl. CPC H04N 5/50; H04N 5/21; H04N 5/455
USPC 348/607

(57) ABSTRACT

There is provided a receiving apparatus including at least one divider configured to divide a high-frequency signal received by an antenna, a high-frequency processing unit configured to output a reception signal obtained by mixing the high-frequency signal divided by the divider and a local oscillation frequency generated by a local oscillator that includes a voltage-controlled oscillator, and a control unit configured to execute voltage-controlled oscillator optimization for searching for a relationship between a control voltage applied to the voltage-controlled oscillator and a local oscillation frequency of the voltage-controlled oscillator, and increase a clock frequency speed when executing the optimization of the voltage-controlled oscillator.

### CROSS REFERENCES TO RELATED APPLICATIONS

The present application claims priority to Japanese Priority Patent Application JP 2013-054937 filed in the Japan Patent Office on Mar. 18, 2013, the entire content of which is hereby incorporated by reference.

### BACKGROUND

The present disclosure relates to a receiving apparatus that receives broadcast waves and a receiving method employing that receiving apparatus. Specifically, the present disclosure relates to technology for receiving a plurality of broadcast waves.

Recently, the number of terrestrial broadcast and satellite broadcast channels has been increasing. There is thus an increasing need for a function that enables a user to watch one program while simultaneously watching another program that is being broadcast at the same time, or that enables two or more different programs being broadcast at the same time to be recorded. To realize such a function, a plurality of tuner unit systems for performing channel selection and demodulation of the broadcast waves are provided in the receiving apparatus that receives the broadcast waves. Broadcast signals received by an antenna and divided by a divider are fed to this plurality of tuner unit systems. For example, JP 2003-0309776A describes a tuner apparatus that is capable of receiving in parallel two or more broadcast waves from different broadcast methods by configuring so that the broadcast signals received by the antenna are divided by a divider and fed to the tuner unit in each system.

### SUMMARY

In such a reception apparatus having a plurality of tuner unit systems, noise can appear in the picture that is being during demodulated, such as when demodulation of the broadcast wave of a predetermined channel with one tuner unit the channel is switched with another tuner unit. This phenomenon occurs when several broadcast waves having the same frequency are received by a plurality of different tuner units due to a channel selection operation being performed. This causes the reception performance of the tuner units that are receiving broadcast waves to deteriorate due to the local oscillation frequencies generated by the local oscillators in the respective tuner units interfering with each other.

Such a phenomenon can also occur in situations other than when performing channel selection. For example, this phenomenon can also occur when executing VCO (voltage-controlled oscillator) calibration (optimization) in the tuner units. The term “VCO calibration” refers to an operation in which the VCO is driven in the actual operating environment, and a relationship between the oscillation frequency and the control voltage at that time is searched for. VCO calibration is normally carried out when starting up the tuner units and during channel selection, for example.

A variable capacitance element is generally used for the frequency selection element used to change the VCO oscillation frequency. The characteristics of a variable capacitance element vary based on factors such as the temperature and humidity during use and the voltage of the power source. Consequently, VCO calibration is performed when starting up the tuner units and during channel selection in order to accurately grasp the control voltage when trying to obtain a desired reception frequency.

However, in order to search for a relationship between the oscillation frequency and the control voltage when VCO calibration is executed, an oscillator is actually made to oscillate. Consequently, the local oscillation frequency, and multiplication and division components thereof, leak to other tuner units that are receiving broadcast waves. This leakage can appear as noise in the picture that is being received. Namely, the execution of VCO calibration can cause the reception performance of other tuner units that are receiving broadcast waves to deteriorate.

It is desirable in the present disclosure, which was created in view of the points described above, to, in a receiving apparatus that includes a plurality of tuner unit systems, reduce noise that appears in a picture that is being received by other tuner units during execution of voltage-controlled oscillator optimization.

According to an embodiment of the present disclosure, there is provided a receiving apparatus which includes at least one divider, a high-frequency processing unit, and a control unit. The divider is configured to divide a high-frequency signal received by an antenna. The high-frequency processing unit is configured to output a reception signal obtained by mixing the high-frequency signal divided by the divider and a local oscillation frequency generated by a local oscillator that includes a voltage-controlled oscillator. The control unit is configured to execute voltage-controlled oscillator optimization for searching for a relationship between a control voltage applied to the voltage-controlled oscillator and a local oscillation frequency of the voltage-controlled oscillator, and increase a clock frequency speed when executing the optimization of the voltage-controlled oscillator.

According to another embodiment of the present disclosure, there is provided a receiving method which includes dividing a high-frequency signal received by an antenna, then outputting a reception signal obtained by mixing the divided high-frequency signal and a local oscillation frequency generated by a local oscillator that includes a voltage-controlled oscillator, and then increasing a clock frequency speed when executing voltage-controlled oscillator optimization for searching for a relationship between a control voltage applied to the voltage-controlled oscillator and a local oscillation frequency of the voltage-controlled oscillator.

By configuring the reception apparatus and performing the processing in the above manner, the time that it takes to execute voltage-controlled oscillator optimization is shortened.

According to one or more of embodiments of the present disclosure, in a receiving apparatus that includes a plurality of tuner unit systems, the time taken to execute voltage-controlled oscillator optimization can be shortened. Therefore, the duration that noise appears in a picture during reception with other tuner units when voltage-controlled oscillator optimization is executed can be shortened. Namely, the amount of noise that appears in a picture during reception with other tuner units can be reduced.

Additional features and advantages are described herein, and will be apparent from the following Detailed Description and the figures.

### BRIEF DESCRIPTION OF THE FIGURES

FIG. 1 is a block diagram illustrating a configuration example of a receiving apparatus according to a first embodiment of the present disclosure;

FIG. 2 is a block diagram illustrating a configuration example of a turner unit according to a first embodiment of the present disclosure;

FIG. 3 is a block diagram illustrating a configuration example of a VCO according to a first embodiment of the present disclosure;

FIG. 4 is a diagram illustrating a voltage-controlled tuning capacitor capacitance value-control voltage characteristic according to a first embodiment of the present disclosure, and a relationship between the oscillation frequency of an oscillator and the control voltage, in which FIG. 4A illustrates the a voltage-controlled tuning capacitor capacitance value-control voltage characteristic and FIG. 4B illustrates the relationship between the oscillation frequency of an oscillator and the control voltage;

FIG. 5 is an explanatory diagram illustrating a subband configuration example according to a first embodiment of the present disclosure;

FIG. 6 is a flowchart illustrating an example of subband search processing according to a first embodiment of the present disclosure;

FIG. 7 is an explanatory diagram illustrating an example of the oscillation frequency bandwidth covered by each band according to a first embodiment of the present disclosure;

FIG. 8 is a block diagram illustrating a configuration example of a local oscillator according to a first embodiment of the present disclosure;

FIG. 9 is a flowchart illustrating an example of receiving processing according to a first embodiment of the present disclosure;

FIG. 10 is a flowchart illustrating an example of receiving processing according to a second embodiment of the present disclosure;

FIGS. 11A to 11F illustrate a comparison between the receiving processing according to the second embodiment of the present disclosure and the amount of radiation from a tuner unit; and

FIG. 12 is a graph illustrating a comparison between spurious level measured when the blocks not involved in the local oscillation frequency search operation are made to rest and spurious level measured when the blocks are not made to rest.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Examples of the receiving apparatus according to an embodiment of the present disclosure will now be described with reference to the drawings. However, the present disclosure is not limited to the following examples.

### 1. First Embodiment of the Present Disclosure

(example in which the internal clock speed is increased during a local oscillation frequency search operation)

### 1-1. Receiving Apparatus Configuration

### 1-2. Receiving Method Employing the Receiving Apparatus

### 2. Second Embodiment of the Present Disclosure

(example in which the blocks not involved in the local oscillation frequency search operation set to a rest state)

### 3. Other Modified Examples

### 1. First Embodiment of the Present Disclosure

1-1. Receiving Apparatus Configuration

1-1-1. Outline of a Configuration Example of the Receiving Apparatus

First, the receiving apparatus according to an embodiment of the present disclosure will be described with reference to FIG. 1. FIG. 1 is a block diagram illustrating an outline of a configuration example of a receiving apparatus 10 according to the present embodiment. The receiving apparatus 10 according to the present embodiment receives a broadcast signal broadcast from a digital satellite, and decodes encoded video and audio related data included in the received broadcast signal. Further, the receiving apparatus 10 transmits the decoded data to a not-illustrated display device, and records the decoded data in a not-illustrated recording medium. It is noted that although in the present embodiment an example is illustrated in which the receiving apparatus 10 receives a broadcast signal broadcast from a satellite, the present disclosure is not limited to this. For example, the present disclosure may also be applied in a receiving apparatus that receives other broadcast waves, such as from a terrestrial digital television broadcast or a cable television broadcast.

Further, the receiving apparatus 10 according to the present embodiment has a configuration in which the VCO (which is not illustrated in FIG. 1) has a plurality of oscillation frequency ranges of a local oscillation frequency called “subbands”. Based on the desired reception frequency, the optimum subband is selected from among the plurality of subbands. In addition, in the present embodiment too, similar to the apparatus described as related art, a variable capacitance element (variable capacitance diode) is used as the VCO frequency selection element. Consequently, to accurately grasp the relationship between the local oscillation frequency and the control voltage in the actual operating environment, VCO calibration is carried out each time a channel is selected with a below-described tuner unit 4.

In VCO calibration, an oscillation frequency is generated at each subband in a state in which the control voltage applied to the VCO is fixed at a predetermined value, and a comparison is made between the obtained oscillation frequencies and a target frequency corresponding to the desired reception frequency. Further, the subband that generated the oscillation frequency at which the difference with the reception frequency is within a predetermined range is selected as the subband corresponding to the reception frequency. The receiving apparatus 10 according to an embodiment of the present disclosure shortens the channel selection (subband search) duration during VCO calibration by increasing the speed of the internal clock when executing VCO calibration. Consequently, the time that the local oscillation frequency leaks out to other tuner units 4 can be shorted.

The receiving apparatus 10 illustrated in FIG. 1 includes dividers 2-1 to 2-(n-1) (wherein n is a natural number) for dividing the broadcast signals (hereinafter sometimes referred to as “high-frequency signals”) received by an antenna 1, attenuators 3-1 to 3-n, and tuner units 4-1 to 4-n. It is noted that in the following description, in places where it is not necessary to describe each of the dividers 2-1 to 2-(n-1) separately, these units are collectively referred to as the divider 2. The same also applies for the attenuator 3 and the tuner unit 4.

The attenuators 3-1 to 3-n are devices that attenuate an input high-frequency signal. By setting the amount of attenuation to an appropriate value, each of the tuner units 4 can set the high-frequency signal to be at an appropriate level.

For example, if the amount of attenuation set for the attenuator 3 is set at a value that is inversely proportional to the distance from the antenna 1 (the distance over which the high-frequency signal is transmitted), the signal level of the high-frequency signal input to each tuner unit 4 can be made the same. For example, if a low amount of attenuation is set for the attenuator 3 that is arranged in front of a tuner unit 4 positioned away from the antenna 1, such as tuner unit 4-n, a large amount of attenuation is set for a tuner unit 4 arranged near the antenna 1, such as tuner unit 4-1. Setting in this manner can prevent the reception performance of each tuner unit 4 from being different based on their arrangement position.

It is noted that although in the present embodiment the receiving apparatus 10 having the attenuator 3 is given as an example, a receiving apparatus that does not have the attenuator 3 may also be employed.

The tuner units 4-1 to 4-4 extract and demodulate the high-frequency signal from a desired channel selected by a not-illustrated channel selection unit from among the high-frequency signals received by the antenna 1. Further, after performing error correction on the demodulated digital signal, a video signal and an audio signal are obtained by separating and decoding each of the error-corrected TS (transport stream) packets.

### 1-1-2. Tuner Unit Configuration Example

Next, an example of the internal configuration of each tuner unit 4 will be described with reference to the block diagram of FIG. 2. The tuner unit 4 according to the present embodiment is configured so as to obtain a 950 MHz to 2,150 MHz reception signal by, using direct conversion, detecting high-frequency signals in the 1 to 2 GHz band output from the antenna 1 (refer to FIG. 1). It is noted that the frequency bandwidth of the reception signal is not limited to this example, some other value may be set. Further, the detection method is also not limited to direct conversion, some other method may be employed, such as a superheterodyne method and the like, based on the kind of broadcast waves that are received. In addition, the high-frequency signal in the 1 to 2 GHz band output from the antenna 1 (refer to FIG. 1) is an IF (intermediate frequency) signal that has been subjected to frequency conversion by a circuit in the antenna.

The tuner unit 4 includes a high-frequency processing unit 40, a demodulator 41, a channel selection unit 42, a storage unit 43, and a host CPU (central processing unit) 44 that acts as a control unit.

The high-frequency processing unit 40 includes a LNA (low noise amplifier) 410, a through circuit 411, and I/Q mixers 412 and 413. Further, the high-frequency processing unit 40 also includes a local oscillator 420 (PLL circuit), a phase shifter 414, variable LPFs (low pass filter) 415 and 416, and base band amplifiers 417 and 418.

The LNA 410 amplifies a high-frequency signal output from the attenuator 3, and also attenuates the local oscillation frequency, and the multiplication and division components thereof, that leak from the subsequent local oscillator 420. The through circuit 411 has a switch 411s that it switches ON/OFF. Specifically, when executing calibration of the VCO (not illustrated in FIG. 2) in the local oscillator 420, the through circuit 411 turns the switch 411s to OFF (open) to turn on the LNA 410. At other times, the through circuit 411 turns the switch 411s to ON. During execution of VCO calibration, since the LNA 410 and the subsequent circuits are connected because the switch 411s is set to OFF, the local oscillation frequency, and the multiplication and division components thereof, that leak from the subsequent local oscillator 420 and are transmitted to a not-illustrated signal input terminal, are attenuated. Consequently, the local oscillation frequency, and the multiplication and division components thereof, that leaks from the local oscillator 420 can be prevented from reaching the signal input terminal (not illustrated), and flowing to the other tuner units 4 via a signal line.

An IF signal amplified by the LNA 410 or an IF signal that has passed through the through circuit 411 is input to the I/Q mixer 412 and/or I/Q mixer 413. The I/Q mixer 412 mixes the input IF signal and a local oscillation signal output from the local oscillator 420, and extracts an I-phase baseband signal. The I/Q mixer 413 mixes the input IF signal and a local oscillation signal that was output from the local oscillator 420 and had its phase shifted by 90° by the phase shifter 414, and extracts a Q-phase baseband signal.

The local oscillator 420 generates a local oscillation frequency that is the same frequency as the desired reception frequency to be received by the antenna 1, and feeds the generated local oscillation frequency to the I/Q mixer 412 and the phase shifter 414. The phase shifter 414 shifts the phase of the local oscillation frequency output from the local oscillator 420 by 90°, and inputs the shifted local oscillation frequency to the I/Q mixer 413.

When performing demodulation using the IQ signals, due to reasons such as signals whose phase is different by 90° can be easily obtained, it is common to set the local oscillation frequency to a value that is twice or more the reception frequency. As described above, since satellite broadcast waves from 950 MHz to 2.150 MHz are received by the tuner unit 4 according to the present embodiment, the oscillation frequency range of the local oscillation frequency is about twice that, at 2,200 MHz to 4,400 MHz.

The I-phase baseband signal extracted by the I/Q mixer 412 is input to the variable LPF 415, and the Q-phase baseband signal extracted by the I/Q mixer 413 is input to the variable LPF 416. The variable LPF 415 limits the frequency of the I-phase baseband signal to a predetermined bandwidth, and outputs to the baseband amplifier 417. The variable LPF 416 limits the frequency of the Q-phase baseband signal to a predetermined bandwidth, and outputs to the baseband amplifier 418.

The variable LPFs 415 and 416 are configured as programmable variable LPFs. The cutoff frequency is set as a setting value in a not-illustrated register. By varying the setting value set in the register, the characteristic of the frequency that is passed by the LPFs can be varied. This enables various kinds of broadcast waves having various occupied bandwidths to be received.

The baseband amplifier 417 adjusts the gain of the I-phase baseband signal output from the variable LPF 415, and outputs the adjusted signal to the demodulator 41. The baseband amplifier 418 adjusts the gain of the Q-phase baseband signal passed through the variable LPF 416, and outputs the adjusted signal to the demodulator 41. The gain of the baseband amplifiers 417 and 418, and the gain of the LNA 410, are adjusted based on an AGC control signal input via a control line 45 from the demodulator 41.

The demodulator 41 demodulates the respective I-phase/Q-phase baseband signal that was input based on a predetermined demodulation method, and performs error correction, such as Reed-Solomon coding, to obtain a TS signal. The TS signal demodulated by the demodulator 41 is separated by a not-illustrated multi-separation unit, and then is decoded by a decoding unit, which is also not illustrated, and extracted as a video signal and an audio signal.

The channel selection unit 42, which is configured from a remote controller and the like, transmits information about the channel selected by the user to the host CPU 44 as channel selection information. The storage unit 43, which is configured from a non-volatile memory and the like, stores the channel selection data and the corresponding setting data. It is noted that generation of the channel selection data is not only performed when a channel has been selected via the channel selection unit 42 configured as a remote controller. For example, channel selection data is also generated when a specific program has been selected via an electronic program guide (EPG) or when a specific program has been selected as a programmed recording.

The host CPU 44 controls the respective units configuring the tuner unit 4. For example, the host CPU 44 reads the setting data used for broadcast reception of the selected channel based on the channel selection data selected by the channel selection unit 42, and sets the respective units in the tuner unit 4 based on the read setting data. Further, during execution of VCO calibration, the host CPU 44 also controls so that the internal clock is sped up. The processing for increasing the speed of the internal clock will be described in more detail below. In addition, during execution of VCO calibration, the host CPU 44 controls the selection of the LNA 410 by opening the switch 411s of the above-described through circuit 411, and also reduces the VCO oscillation current, which is described below.

### 1-1-3. VCO Configuration Example

Next, a configuration example of a VCO 430 in the local oscillator 420 will be described with reference to the block diagram of FIG. 3. The VCO 430 is configured from a LC tuning circuit 431 and an oscillator 432. The oscillator 432 is connected to a variable current source 433. The LC tuning circuit 431 has tuning capacitors 31-1 to 31-m corresponding to each subband, a voltage-controlled tuning capacitor 33, and a tuning inductor 34. The respective elements configuring the LC tuning circuit 431 are connected in parallel. Switches 32-1 to 32-m are respectively connected in series to the tuning capacitors 31-1 to 31-m.

It is noted that in the following description, in places where it is not necessary to describe each of the tuning capacitors 31-1 to 31-m separately, these units are simply referred to as the tuning capacitor 31. Similarly, in places where it is not necessary to describe each of the switches 32-1 to 32-m separately, these units are simply referred to the switch 32.

The tuning capacitor 31 is configured from a diode that is built on a chip, for example. The voltage-controlled tuning capacitor 33 is a variable capacitance diode for controlling a capacitance value. The capacitance value of the voltage-controlled tuning capacitor 33 is controlled by a control voltage Vc applied to its Vc terminal (not illustrated). FIG. 4A illustrates a relationship between the control voltage Vc and the capacitance value Cv of the voltage-controlled tuning capacitor 33. In FIG. 4A, the horizontal axis represents the control voltage Vc (Vt), and the vertical axis represents the capacitance value Cv (pF) of the voltage-controlled tuning capacitor 33. As illustrated in FIG. 4A, the smaller the applied control voltage Vc, the greater the capacitance value Cv of the voltage-controlled tuning capacitor 33, and the greater the applied control voltage Vc, the smaller the capacitance value Cv of the voltage-controlled tuning capacitor 33.

The tuning inductor 34 is configured from an inductor that is built on a chip, for example. Further, the oscillation frequency of the oscillator 432 is controlled by the LC tuning circuit 431 configured from the tuning capacitor 31 whose switch 32 has been set to ON, the voltage-controlled tuning capacitor 33, and the tuning inductor 34. If, for example, one tuning capacitor 31 is provided, an oscillation frequency Fc of the oscillator 432 oscillated by the LC tuning circuit 431 can be calculated by the following formula 1. In formula 1, “L” represents the inductance of the tuning inductor 34, and “C” represents the capacitance value of the tuning capacitor 31.

$$Oscillation frequency Fc = \frac{1}{2 π \sqrt{LC}} \qquad formula 1$$

FIG. 4B illustrates the relationship between the control voltage Vc and the oscillation frequency Fc of the oscillator 432. In FIG. 4B, the horizontal axis represents the control voltage Vc (Vt), and the vertical axis represents the oscillation frequency Fc of the oscillator 432. As illustrated in FIG. 4B, the smaller the applied control voltage Vc, the smaller the oscillation frequency Fc of the oscillator 432, and the greater the applied control voltage Vc, the greater the oscillation frequency Fc of the oscillator 432.

In practice, m-number of tuning capacitors 31 are provided. The oscillation frequency Fc of the oscillator 432 in this case can be calculated by the following formula 2. In formula 2, “L” represents the inductance of the tuning inductor 34, and “C32-1” to “C32-m” represent the capacitance value of each tuning capacitor 31-1 to 31-m, respectively.

Namely, the larger the number of tuning capacitors 31 whose switch 32 is ON (refer to FIG. 3), the lower the oscillation frequency Fc, and the smaller the number of tuning capacitors 31 whose switch 32 is ON, the higher the oscillation frequency Fc.

$$Oscillation frequency Fc = \frac{1}{2 π \sqrt{L \times ( Cv + C 32 - 1 + C 32 - 2 + … C 32 - m )}} \qquad formula 2$$

FIG. 5 illustrates the relationship between oscillation frequency Fc of the oscillator 432 osciallted by the LC tuning circuit according to the present embodiment, namely, the LC tuning circuit 431 illustrated in FIG. 3, and the control voltage Vc. The horizontal axis represents the control voltage Vc (Vt), and the vertical axis represents the oscillation frequency Fc (f) of the oscillator 432. When all of the tuning capacitors 31-1 to 31-m illustrated in FIG. 2 are ON and the control voltage Vc is set at a predetermined voltage (e.g., 0.9 V), the oscillation frequency Fc of the oscillator 432 is a value denoted by “F1” in the graph.

Further, the oscillation frequency Fc also varies based on the changes in the applied control voltage Vc. If the value of the control voltage Vc is varied from its minimum value to its maximum value, the oscillation frequency Fc changes from an oscillation frequency F1n, which is its minimum value, to an oscillation frequency F1x, which is its maximum value. Namely, when all of the tuning capacitors 31 are ON, the bands that can be covered by that oscillation frequency Fc are from the oscillation frequency F1n to the oscillation frequency F1x. In the present embodiment, the individual bands with the oscillation frequency Fc, which vary based on the number of tuning capacitors 31 that are ON, are referred to as a “subband”. In FIG. 5, the subband that is covered by the oscillation frequency Fc obtained when all of the tuning capacitors 31 are ON is denoted as subband Sb-1.

Of the tuning capacitors 31, if just the tuning capacitor 31-1 (refer to FIG. 3) is turned OFF, with the value of the control voltage Vc fixed, the LC tuning circuit 431 generates an oscillation frequency F2 that is a higher frequency than the oscillation frequency F1. Consequently, by increasing/decreasing the control voltage Vc, the duration from when the oscillation frequency Fc of the oscillator 432 goes from the minimum oscillation frequency F2 to the maximum oscillation frequency F2x varies based on the value of the control voltage Vc. In FIG. 5, the band with the oscillation frequency Fc that is generated when just one of the tuning capacitors 31 is turned off is denoted as subband Sb-2.

As described above, the tuning capacitor 31 in the LC tuning circuit 431 is configured from a variable capacitance diode that is built on the chip. Therefore, the variable range of the capacitance value of each tuning capacitor 31 is small, at about a few pF (0 V to 3.3 V). In the present embodiment, by forming a plurality of subbands by providing a plurality of such tuning capacitors 31 that have a small variable range, a wide range can be covered as the local oscillation frequency oscillation frequency range.

When a subband Sb corresponding to a reception frequency is selected, the frequency obtained by dividing the oscillation frequency Fc of the oscillator 432 is synchronized with the reception frequency by performing feedback control with the local oscillator 420 configured as a PLL circuit. However, since a variable capacitance diode (variable capacitance element) is used as the voltage-controlled tuning capacitor 33 of the LC tuning circuit 431, the capacity-voltage (C-V) characteristic varies based on factors such as the surrounding temperature and humidity during use and the voltage of the power source. Namely, the subband Sb corresponding to the reception frequency can also vary depending on changes in such factors. Consequently, in the present embodiment, the unevenness in the C-V characteristic of the voltage-controlled tuning capacitor 33 is evened out by, for example, performing “VCO calibration” for searching for the subband Sb corresponding to the reception voltage each time channel selection is carried out.

Here, an example of the VCO calibration operation according to the present embodiment will be described with reference to FIG. 5 and the flowchart in FIG. 6. As illustrated in FIG. 6, first, the control voltage Vc applied to the voltage-controlled tuning capacitor 33 is fixed at a predetermined value, such as 0.9 V for example, based on a below-described control logic (step S1). Then, all of the switches 32 connected to the tuning capacitor 31 are turned ON (step S2). In this state, the oscillator 432 is oscillated (step S3), and then a determination is made regarding whether the oscillation frequency Fc from the oscillator 432 is greater than a PLL lock target frequency Ftg that is determined according to the reception frequency (step S4).

If the oscillation frequency Fc is equal to or less than the target frequency Ftg, one of the switches 32 connected to the tuning capacitor 31 is turned OFF (step S5), and then the determination performed in step S4 is carried out again. Further, if it is determined that the oscillation frequency Fc is greater than the target frequency Ftg, PLL feedback control is started at the subband Sb-i (wherein i is a natural number) outputting an oscillation frequency Fov, which is a frequency greater than the target frequency Ftg (step S6).

As illustrated in FIG. 5, the oscillation frequency Fov that is greater than the target frequency Ftg refers to, among the oscillation frequencies Fc generated by the control voltage Vc, whose value is fixed, in step S1 of FIG. 6, a frequency whose value is greater than the target frequency Ftg. The oscillation frequencies Fc have a different value depending on which subband Sb is selected, in other words, the number of tuning capacitors 31 that are connected. In the present embodiment, the subband Sb-i generating the oscillation frequency Fov that is greater than the target frequency Ftg is considered as the subband Sb corresponding to the reception frequency.

It is noted that since the purpose is to search for a subband Sb generating the oscillation frequency Fc having a small difference (within a predetermined range) with the target frequency Ftg, it is possible for the oscillation frequency Fc to be a value that is not greater than the target frequency Ftg. For example, a subband Sb that generates an oscillation frequency Fc that is nearest to the target frequency Ftg among the subband Sb-i that generated the oscillation frequency Fov and subbands Sb-(i-1) that were previously searched, may also be considered to be the subband Sb corresponding to the reception frequency.

Information about which subband is the subband Sb corresponding to the reception frequency is stored until the PLL is locked at the subband Sb determined to correspond to the reception frequency. The information about the subband Sb may be expressed as how many tuning capacitors 31 are connected, for example. It is noted that in addition to the number of tuning capacitors 31, the information about the subband Sb may also include information about the oscillation frequencies Fov that have a greater value than the target frequency Ftg. Further, relationship information about the reception frequency and the subband Sb may be stored in a table, for example, and kept even after the PLL is locked.

Here, returning to FIG. 3, the configuration of the VCO 430 according to the present embodiment will be described again. As described above, the tuning inductor 34 is configured as an inductor that is built on a chip. Consequently, the inductance of the tuning inductor 34 is 0 to 20 nH, which is low, and the Q value is also a low value, of 10 or less. When the VCO 430 configured from such a tuning inductor 34 and the above-described tuning capacitor 31, and the voltage-controlled tuning capacitor 33 is oscillated, normally only high frequencies in the GHz band can be generated. However, in the present embodiment, the oscillation frequency generated by the VCO 430 is divided by a not-illustrated divider into ranges of about 1/32 that of the source oscillation. This enables an oscillation frequency range of 2,200 MHz to 4,400 MHz to be covered, which is about twice that of the 950 MHz to 2,150 MHz employed by satellite broadcasts.

FIG. 7 is an explanatory diagram illustrating a configuration example of the subbands Sb according to the present embodiment. In FIG. 7, the horizontal axis represents the frequency (MHz), and the vertical axis represents the control voltage. The plurality of straight lines that incline upwards to the right shown in the graph of FIG. 7 denote each subband Sb. The subband Sb-1, which has the lowest oscillation frequency, exhibits an oscillation frequency that varies in a state in which all of the tuning capacitors 31 illustrated in FIG. 3 are connected. Further, the subband Sb-m, which has the highest oscillation frequency, exhibits an oscillation frequency that varies in a state in which all of the tuning capacitors 31 have been turned OFF.

As described above, since it is acceptable if a local oscillation frequency in the range of 2,200 MHz to 4,400 MHz is generated by the VCO 430, in the present embodiment, the frequency range that covers the plurality of subbands Sb may also be from 2,200 MHz to 4,400 MHz. However, to avoid a phenomenon in which the desired local oscillation frequency is not obtained during actual operation due to unevenness of the voltage-controlled tuning capacitor 33 configured from a variable capacitance diode, in the receiving apparatus 10 according to the present embodiment, the frequency range of the oscillator 432 is set at 1,950 MHz to 4,850 MHz. Namely, this means that subbands Sb are present in regions other than the 2,200 MHz to 4,400 MHz bandwidth that is used as the local oscillation frequency band. Consequently, the region from 1,950 MHz to 2,200 MHz and the region from 4,400 MHz to 4,850 MHz are also included in the VCO calibration execution target in which subbands Sb are searched for.

However, configuring in this manner means that input frequencies of 1,950 MHz to 2,200 MHz of the VCO 430 during satellite broadcast reception are included in the frequency bands that are scanned during execution of VCO calibration. Consequently, interference with other tuner units 4 occurs not only when the frequencies scanned during execution of VCO calibration completely matches the frequency during channel selection by another tuner unit 4, but even when a much lower frequency, 1,950 MHz for example, is scanned. When the frequency range that covers the subbands Sb is set to exactly the same frequency range as the local oscillation frequency, the same phenomenon also occurs if the frequencies scanned during execution of VCO calibration completely match the frequency during channel selection by another tuner unit 4.

To resolve such a problem, in the receiving apparatus 10 according to an embodiment of the present disclosure, the speed of the internal clock (the clock frequency of the host CPU 44) during execution of VCO calibration is increased. Namely, the duration that interference with other tuner units 4 occurs during reception of a predetermined frequency is shortened by shortening the search time of the subbands Sb during execution of VCO calibration. The processing for increasing the speed of the internal clock will be described with reference to the block diagram of the local oscillator 420 (PLL circuit) illustrated in the following FIG. 8.

The local oscillator 420 illustrated in FIG. 8 is configured as a PLL circuit, which includes a liquid crystal oscillator 421 that generates a reference signal, a divider 422, a phase comparator 423, a loop filter 424, a VCO 430, and a variable divider 425. Further, the local oscillator 420 also includes a divider 426, a frequency counter 427, a control logic 428, a control voltage application unit 429, a divider 440, and a divider 441.

The divider 422 divides a reference frequency generated by the liquid crystal oscillator 421 by 1/R (R divisions) to produce a comparison frequency Frr, and feeds the produced comparison frequency Frr to the phase comparator 423. The phase comparator 423 compares the phase of the comparison frequency Frr, which is the frequency divided by the divider 422, and the phase of a divided frequency Fdv, which was generated by the VCO 430 and divided by the variable divider 425. Then, the phase comparator 423 generates a signal based on that phase difference (an error signal), and inputs the generated signal to the loop filter 424. The loop filter 424 converts the error signal input from the phase comparator 423 into a direct current voltage, and applies the voltage to the VCO 430. The VCO 430 changes the oscillation frequency based on the magnitude of the direct current voltage applied from the loop filter 424, and feeds the generated oscillation frequency to the variable divider 425. By performing such PLL feedback control, the phase of the oscillation frequency Fdv fed to the variable divider 425 is consequently locked to the phase of the comparison frequency Frr. Namely, the oscillation frequency Fdv becomes exactly the same frequency as the comparison frequency Frr.

The variable divider 425 is a divider that generates the divided frequency Fdv by multiplying the reference frequency generated by the liquid crystal oscillator 421 by 1/N (N divisions) or N times. In the present embodiment, the overall division ratio is switched between “2” to “32” by adjusting the values for the division ratio R of the divider 422 and the division ratio N of the variable divider 425. In the thus-configured PLL circuit, the PLL is locked at the point when the difference between the local oscillation frequency generated by the VCO 430 and the desired frequency is sufficiently small.

The divider 426 is a divider that is selected during execution of VCO calibration. The oscillation frequency generated by the VCO 430 is multiplied by 1/M times (M divisions), and input to the frequency counter 427. The division ratio M at the divider 426 is set to, for example, “32” or the like. It is noted that in the present embodiment, although the divider 426 for dividing the frequency input to the frequency counter 427 is provided because the local oscillation frequency band of the VCO 430 is set at twice the value of the reception frequency, the divider 426 may be omitted in cases such as when the local oscillation frequency band and the reception frequency are the same, for example.

The frequency counter 427 measures the local oscillation frequency Fc of the VCO 430 by counting the frequencies divided by the divider 426 as inputs, and calculates the difference between the measured local oscillation frequency Fc and the comparison frequency Frr that was generated based on the desired target frequency Ftg. This difference calculation processing is performed for each subband Sb illustrated in FIG. 5 generating the oscillation frequencies F1, F2 . . . Fok. Namely, this processing is carried out until the subband Sb that generates an oscillation frequency Fov that is greater than the comparison frequency Frr generated based on the target frequency Ftg is found.

The control logic 428 controls the VCO 430 and the control voltage application unit 429 based on information about the difference calculated by the frequency counter 427. Specifically, if it is determined that the oscillation frequency Fc at the selected subband Sb is lower than the comparison frequency Frr, the control logic 428 issues a command for switching the subband Sb to the VCO 430. Further, the control logic 428 also controls the control voltage application unit 429 so that the control voltage Fv is fixed at, for example, 0.9 V. If it is determined that the oscillation frequency Fc at the selected subband Sb is greater than the comparison frequency Frr, the control logic 428 controls so that the source applying the voltage to the loop filter 424 switches to from the control voltage application unit 429 to the phase comparator 423. The control voltage application unit 429 applies a control voltage instructed by the control logic to the VCO 430 via the loop filter 424.

Namely, during the search for the subband Sb generating the oscillation frequency Fov, the oscillation frequency Vc of the VCO 430 is controlled by a loop formed from the VCO 430, the divider 426, the frequency counter 427, the control logic 428, the control voltage application unit 429, and the loop filter 424. After the subband Sb generating the oscillation frequency Fov has been found, the oscillation frequency Vc of the VCO 430 is controlled by a loop formed from the VCO 430, the variable divider 425, the phase comparator 423, and the loop filter 424. Further, the PLL is locked at the point when the difference between the oscillation frequency generated by the VCO 430 and the desired reception frequency is sufficiently small.

The divider 440 generates a comparison frequency by multiplying the reference frequency generated by the liquid crystal oscillator 421 by 1/F (F divisions) times, and feeds the generated comparison frequency to the frequency counter 427 and the control logic 428. In the present embodiment, the division ratio F of the divider 440 when actually selecting a channel (when receiving a broadcast signal) is different from when executing VCO calibration. Specifically, if the liquid crystal oscillator 421 reference frequency is set to 16 MHz, for example, the divisio ratio F is set to “16” during channel selection and to “1” when executing VCO calibration.

The clock frequency of the local oscillator 420 configured as a PLL circuit is a value obtained by dividing the reference frequency generated by the liquid crystal oscillator 421 by the division ratio F. Namely, by changing the division ratio F of the divider 440 during execution of VCO calibration to “1”, for example, the clock frequency of the local oscillator 420 becomes 16 MHz (reference frequency/1 (division ratio)=16). Since the normal clock frequency of the local oscillator 420 during channel selection is 16 MHz/16=1 MHz, it can be understood that the clock frequency of the PLL circuit is increased during execution of VCO calibration. Consequently, since the minimum step width for turning over the frequency counter 427 decreases (in the present embodiment, 1 MHz), the interval during which the control voltage is applied to the local oscillator 420 also decreases. Namely, the time taken to search the local oscillation frequency for one subband Sb is shorter.

The divider 441 performs processing for matching with the reception frequency band by dividing the local oscillation frequency generated by the VCO 430.

By performing control like this, since the time taken to execute VCO calibration (the time taken to search for the subband Sb generating the oscillation frequency Fov) is shorter, the duration that the local oscillation frequency, and the multiplication and division components thereof, leak from the VCO 430 is itself also shorter. When the present inventors actually measured the time taken to perform the local oscillation frequency search for one subband Sb, when the division ratio F was set at “16”, the time taken was 64 μs, while when the division ratio F was set at “1”, the time taken was 4 μs.

In the present embodiment, the division ratio F of the divider 440 is set by referring to the processing time that the demodulator 41 takes to perform error correction. Namely, the value for the division ratio F is determined so that the time taken to search for the subband Sb generating the oscillation frequency Fov fits within the error correction processing time. The error correction processing time can be calculated by the following formula.

Symbol length (/frame)/broadcast signal transmission rate Formula 3

The “symbol length (/frame)” can be determined by the following formula.

(Error correctable bit number(units: bytes))×(block interleave length (units: frames))×symbol rate Formula 4

For example, the type of error correction that is performed by the demodulator 41 is “shortened Reed-Solomon (204, 188)”. If the broadcast waves to be received are a BS digital broadcast, the parameters plugged into the above formulae 3 and 4 are the following values.

Error correctable bit number=Error correctable bit number: 8 (bytes)×8 (frames)=64

(Bytes)

Block interleave length: 8 (frames)

Coding rate: ½

Broadcast signal transmission rate: 28.86 (Mb/s)

Therefore, based on formula 1:

64 (bytes)×8 (frames)×½=256 (symbols)

Plugging this into formula 2 gives the following calculation.

256 (symbols)/28.86 (Mb/s)=8.87 (μs)

As described above, by setting the division ratio F of the divider 440 in the local oscillator 420 to “1”, the time taken to search the local oscillation frequency for one subband Sb is “4 μs”. Namely, this is shorter than the error correction processing time of 8.87 μs. Consequently, even if a bit error occurs due to execution of VCO calibration, that error can be corrected by error correction by the demodulator 41.

It is noted that although an example was described here in which the time taken to search the local oscillation frequency for one subband Sb fits within the error correction processing time range, the present disclosure is not limited to this. The division ratio F may be set to another value, as long as the time taken to search the local oscillation frequency for one subband Sb fits is shorter than in the past.

1-2. Reception Processing Example

Next, an example of the reception processing performed by the host CPU 44 (refer to FIG. 4) will be described with reference to the flowchart illustrated in FIG. 9. First, the host CPU 44 determines whether the execution timing for VCO calibration has arrived (step S11). The execution timing for VCO calibration is set as a predetermined timing, such as when the tuner unit 4 is started, when the received channel is changed and the like. If it is determined that the execution timing for VCO calibration has not arrived, the determination performed in step S11 is continued. If it is determined that the execution timing for VCO calibration has arrived, the host CPU 44 then determines whether another 4 is operating (step S12). If it is determined that another tuner unit 4 is not operating, the processing is finished.

If it is determined that another tuner unit 4 is operating, the cutoff frequency of the variable LPF 415 (refer to FIG. 2) is calculated based on a related-art clock frequency without changing the setting of the division ratio F (step S13). Then, the clock speed of the local oscillator 420 configured as a PLL circuit is increased (step S14). In the present embodiment, as described above, the speed of the local oscillator 420 clock frequency can be increased by setting the division ratio F to a large value.

Next, the LNA 410 side is selected by opening the switch 411s (refer to FIG. 4) of the through circuit 411, and control is performed to suppress the oscillation current of the local oscillator 420 (step S15). Then, VCO calibration is executed (step S16). After VCO calibration has been executed, the clock frequency of the PLL circuit is returned to its original value (step S17). Then, the through circuit side is selected by turning on the switch 411s of the through circuit 411, and the suppression of the local oscillation current of the local oscillator 420 is stopped (step S18).

It is noted that the respective processes illustrated in steps S14 and S15, and the processing order of steps S17 and S18, is not limited to the above order. These process may be performed in the reverse order.

According to the above-described present embodiment, since the internal clock (in the above example, the clock frequency of the PLL circuit) during execution of VCO calibration is speeded up, the time taken to search for the subband Sb corresponding to the reception frequency is also speeded up. Consequently, the duration that the local oscillation frequency, and the multiplication and division components thereof, leak to the tuner unit 4 is itself also shorter. Therefore, the duration that noise is added to the picture during demodulation by another tuner unit 4 can also be shortened.

Further, according to the above-described present embodiment, the time taken to search the local oscillation frequency for one subband Sb fits within the error correction processing time range. Consequently, even if a bit error occurs due to execution of VCO calibration, that error can be corrected by error correction by the demodulator 41.

In addition, according to the above-described present embodiment, since the LNA 410 is selected during execution of VCO calibration, the amount of leakage of the local oscillation frequency, and the multiplication and division components thereof, is reduced by the LNA 410.

Still further, according to the above-described present embodiment, power consumption due to the oscillation of the VCO 430 is reduced because the oscillation current of the VCO 430 is suppressed during execution of VCO calibration. Consequently, the amount of leakage of the local oscillation frequency, and the multiplication and division components thereof, is also reduced.

Moreover, according to the above-described present embodiment, the time taken to execute VCO calibration is shorter. This not only allows the effects of interference among the tuner units 4 that occurs in the broadcast signal reception band to be reduced, but also the effects of interference among the tuner units 4 that occurs in the oscillation frequency band (GHz band) of the oscillator 432 in the VCO 430 to be reduced.

### 2. Second Embodiment of the Present Disclosure

Next, a second embodiment of the present disclosure will be described with reference to FIGS. 10 and 11. The configuration of the reception apparatus according to the present embodiment is the same as the that of the receiving apparatus 10 illustrated in FIG. 1. Namely, the configuration of the tuner units in the reception apparatus is the same as the tuner unit 4 illustrated in FIG. 2, the configuration of the VCO in the tuner units is the same as the VCO 430 illustrated in FIG. 3, and the configuration of the local oscillator is the same as the local oscillator 420 illustrated in FIG. 8.

FIG. 10 is a flowchart illustrating the processing performed during execution of VCO calibration by the host CPU 44 (refer to FIG. 1) as a control unit. A receiving apparatus 10a (not illustrated) according to the present embodiment sets blocks not involved in the search operation for the subband Sb (local oscillation frequency search operation) to a rest state during execution of VCO calibration.

First, the host CPU 44 (refer to FIG. 2) determines whether the execution timing for VCO calibration has arrived (step S21). The execution timing for VCO calibration is set as a predetermined timing, such as when the tuner unit 4 is started, when the received channel is changed and the like. If it is determined that the execution timing for VCO calibration has not arrived, the determination performed in step S21 is continued. If it is determined that the execution timing for VCO calibration has arrived, the host CPU 44 then determines whether another 4 is operating (step S22). If it is determined that another tuner unit 4 is not operating, the processing is finished. If it is determined that another tuner unit 4 is operating, the host CPU 44 sets so that the variable divider 425 (refer to FIG. 10), the I/Q mixers 412 and 413, and the baseband amplifiers 417 and 418 ((refer to FIG. 2, respectively), which are blocks not involved in the local oscillation frequency search operation, are in a rest state (step S23).

The term “rest state” used here refers to a state in which a small current at a level sufficient to keep each of these blocks from being completely turned off is flowing. A “small current” is a current at a level sufficient that a certain charge remains in the capacitative elements included in the semiconductor elements configuring these blocks, or that is within the capacity of the existing parasitic capacitance that is equal to this. By keeping a certain amount of charge within the capacity of the semiconductor elements, the time taken to return to a normal state from the rest state can be shortened. Further, by keeping a certain amount of charge within the capacity of the semiconductor elements, changes in the input impedance of the VCO 430 are eliminated even when again returning to a normal state. Consequently, the oscillation frequency of the VCO 430 can be prevented from shifting from the originally intended frequency as a result of changes in impedance.

Next, the host CPU 44 executes VCO calibration (step S24). Namely, the host CPU 44 starts the subband Sb search using the VCO 430, and oscillates at a desired frequency. Then, the host CPU 44 determines whether VCO calibration has finished (step S25). The determination performed in step S25 is continued until it is determined that VCO calibration has finished. When VCO calibration has finished, the host CPU 44 determines whether the PLL has been locked at the subband Sb corresponding to the reception frequency (step S26). During the period that the PLL is not locked, the determination performed in step S26 is continued.

If the PLL has been locked at the subband Sb corresponding to the reception frequency, operation of the variable divider 425, the I/Q mixers 412 and 413, and the baseband amplifiers 417 and 418 that were set to a rest state in step S23 is restarted (step S27). Consequently, a baseband signal generated by the local oscillator 420a, divided by the variable divider 425, mixed with the input RF signal by the I/Q mixers 412 and 413, and amplified by the baseband amplifiers 417 and 418 is again output from the receiving apparatus 10a.

FIG. 11 is a diagram illustrating an example of change in the amount of signal radiation when the processing illustrated in FIG. 10 is performed by the receiving apparatus according to the present embodiment. FIGS. 11A, 11C, and 11E are block diagrams of a configuration example of the tuner unit 4, and FIGS. 11B and 11D are graphs illustrating the frequency and signal level (power) of a signal leaking from the tuner unit 4.

FIG. 11A illustrates a state in which the variable divider 425, the I/Q mixers 412 and 413, and the baseband amplifiers 417 and 418 have been set to a rest state due to execution of VCO calibration. The blocks that are in a rest state have been colored in. By performing such processing, the amount of radiation of a signal from the tuner unit 4 is limited to just the radiation that is emitted from the local oscillator 420. Consequently, as illustrated in FIG. 11B, the amount of radiation of a signal from the tuner unit 4 is less than the amount of radiation immediately before rest.

FIG. 11C is a conceptual diagram that illustrates using a block diagram the state of the tuner unit 4 during VCO calibration execution. VCO calibration is carried out while the variable divider 425, the I/Q mixers 412 and 413, and the baseband amplifiers 417 and 418 are still in a rest state. FIG. 11D is a diagram illustrating the amount of radiation of a signal from the tuner unit 4 during execution of VCO calibration. During VCO calibration execution, as described above, since a subband Sb search is being carried out, there is a wide range of frequencies that are emitted. However, since the signal level is small, the amount of unwanted radiation on other tuner units 4 is also suppressed to a low level.

FIG. 11E is a conceptual diagram that illustrates using a block diagram the state of the tuner unit 4 after VCO calibration has finished. After VCO calibration has finished, operation of the variable divider 425, the I/Q mixers 412 and 413, and the baseband amplifiers 417 and 418 is restarted. Consequently, as illustrated in FIG. 11F, the amount of radiation of a signal from the tuner unit 4 returns to the level before these respective blocks were set to a rest state. Namely, the amount of unwanted radiation on other tuner units 4 also increases.

However, since the frequency of the signal that is emitted at this point is fixed (is a fixed frequency), there is no interference with the other tuner units 4 so long as this fixed frequency and the oscillation frequency Fc at the other tuner units 4 do not have a specific frequency relationship. The condition for the fixed frequency and the oscillation frequency Fc at the other tuner units 4 forming this specific frequency relationship can be investigated beforehand. Therefore, interference among the frequencies can be prevented by, based on the investigated results, setting so that the respective oscillation frequencies Fc are separate from one another.

According to the above-described present embodiment, during VCO calibration execution, the variable divider 425, the I/Q mixers 412 and 413, and the baseband amplifiers 417 and 418 are in a rest state. Therefore, the amount of signal radiation that can possibly become unwanted radiation on the other tuner units 4 that are receiving broadcast waves from other channels is limited to just the radiation that is emitted from the local oscillator 420. Consequently, the absolute amount of radiation in the air decreases. Further, by setting the I/Q mixers 412 and 413 and the baseband amplifiers 417 and 418 to a rest state, from a wiring perspective, the RF signal input terminal of other receiving apparatuses 10 and the RF signal input terminal of this receiving apparatus 10 are essentially cut off from each other during channel selection of the other channel broadcast waves. Namely, according to the present embodiment, the amount of noise caused by unwanted radiation that appears in a picture during reception by other tuner units 4 can be reduced.

In addition, by setting the I/Q mixers 412 and 413 to a rest state, the occurrence of a frequency of the sum of and the difference between the two different frequencies that are input to the I/Q mixers 412 and 413, or the frequency (spurious frequency) of the sum of and the difference between at the double and triple harmonic, can be reduced. Still further, by setting the baseband amplifiers 417 and 418 to a rest state, spurious frequencies produced by the I/Q mixers 412 and 413 can be prevented from being amplified.

FIG. 12 is a graph illustrating a comparison between spurious level measured when the blocks not involved in the local oscillation frequency search operation according to the present embodiment are made to rest and spurious level measured when the blocks are not made to rest as in a usual case. The horizontal axis of the graph represents spurious level (units: dBm), and the vertical axis represents frequency (units: MHz). The spurious level measured when the blocks not involved in the local oscillation frequency search operation are in a rest state is demoted by the solid line, and the spurious level measured when the blocks are not made to rest as in a related-art case is denoted by the dotted line.

As illustrated in FIG. 12, it can be seen that from around 1,300 MHz to around 2,100 MHz where measurement was carried out, the spurious level denoted by the solid line when the processing according to the present embodiment was performed is a lower value than in the related-art case. Especially, around 2,100 MHz, the spurious level measured when the blocks are not made to rest as in the related-art case is about −105 dBm, whereas the spurious level denoted by the solid line when the processing according to the present embodiment was performed is a low value of about −120 dBm. Namely, the impact on other tuner units 4 can be reduced by the amount of decrease in the spurious level.

### 3. Other Modified Examples

It is noted that although in the above-described second embodiment of the present disclosure an example was described in which during execution of VCO calibration the variable divider 425, the I/Q mixers 412 and 413, and the baseband amplifiers 417 and 418 are set to a rest state, the present disclosure is not limited to this example. Other blocks may also be set to a rest state, as long as such blocks are not the VCO 430. For example, if a preamplifier is provided prior to the variable divider 425 or in the VCO 430, this preamplifier may also be set to a rest state during execution of VCO calibration. By processing in this manner, the output from the preamplifier of a signal with a large amplitude caused by signal distortion can be prevented.

Further, in the respective embodiments of the present disclosure described above, although an example was described in which the VCO 430 has a plurality of subbands Sb, the present disclosure is not limited to this. For example, as long as the calibration (optimization) of the VCO 430 can still be executed, the tuning capacitor 31 of the oscillator in the VCO 430 may be configured from a single variable capacitance diode.

In addition, in the respective embodiments of the present disclosure described above, although an example was described in which the VCO 430 is mounted on an IC, the present disclosure is not limited to this. The present disclosure may also be applied in a configuration in which, like in the past, the tuning capacitor 31 of the VCO 430 is provided externally to the IC.

Still further, in the respective embodiments of the present disclosure described above, although an example was described in which the tuning capacitor 31 acting as a frequency selection element was configured from a variable capacitance diode, the present disclosure is not limited to this. As long as a variable capacitance element is used, the present disclosure may also be applied in a configuration in which an element other than a variable capacitance diode is used.

Still even further, in the respective embodiments of the present disclosure described above, although an example was described in which VCO calibration was executed each time channel selection is performed, the present disclosure is not limited to this. VCO calibration can be executed only at start-up of the tuner unit 4 or at some other timing.

Moreover, in the respective embodiments of the present disclosure described above, although an example was described in which the search of the subbands Sb is performed in order from the subband Sb-1 having the lowest oscillation frequency Fc, the present disclosure is not limited to this. For example, the search of the subbands Sb can be performed in order from the subband Sb-m having the highest oscillation frequency Fc, or start from either end of the subbands Sb and proceed toward the center.

Further, in the respective embodiments of the present disclosure described above, although an example was described in which, during VCO calibration execution, the internal clock speed is increased and the blocks other than the VCO 430 configuring the tuner unit 4 are set to a rest state, the present disclosure is not limited to this. This processing is not limited to when performing “calibration”, and can be carried out during the local oscillation frequency search for some other purpose.

In addition, in the respective embodiments of the present disclosure described above, although an example was described in which the PLL loop is not operated during the subband Sb search, it is operated after the subband Sb has been found, the present disclosure is not limited to this. For example, the present disclosure may also be applied in a configuration in which the frequency is increased or decreased one step at a time while the PLL is locked.

Still further, in the respective embodiments of the present disclosure described above, although an example was described in which the demodulator 41 performs error correction based on Reed-Solomon coding, the present disclosure is not limited to this. Some other method may be employed, as long as it is an error correction method that has error correction slots (time slots).

Still even further, as described above, the oscillation frequency of the VCO 430 is not limited to being set at twice the reception frequency, some other multiple or the same frequency as the reception frequency may be set. Moreover, as described above, the present disclosure is not limited to the reception of satellite broadcast waves, the present disclosure may also be applied in a configuration in which broadcast waves from some other method, such as from a terrestrial digital broadcast, are received.

It should be understood by those skilled in the art that various modifications, combinations, sub-combinations and alterations may occur depending on design requirements and other factors insofar as they are within the scope of the appended claims or the equivalents thereof.

Additionally, the present application may also be configured as below.

(1) A receiving apparatus including:

at least one divider configured to divide a high-frequency signal received by an antenna;

a high-frequency processing unit configured to output a reception signal obtained by mixing the high-frequency signal divided by the divider and a local oscillation frequency generated by a local oscillator that includes a voltage-controlled oscillator; and

a control unit configured to execute voltage-controlled oscillator optimization for searching for a relationship between a control voltage applied to the voltage-controlled oscillator and a local oscillation frequency of the voltage-controlled oscillator, and

increase a clock frequency speed when executing the optimization of the voltage-controlled oscillator.

(2) The receiving apparatus according to (1), wherein a frequency selection element in the voltage-controlled oscillator includes a variable capacitance element.
(3) The receiving apparatus according to (1) or (2),

wherein the frequency selection element is configured from a plurality of tuning capacitors, a voltage-controlled tuning capacitor, and a tuning inductor, and

wherein the plurality of tuning capacitors and the voltage-controlled tuning capacitor are connected to each other in parallel.

(4) The receiving apparatus according to (3),

wherein the plurality of tuning capacitors are switched on and off by a switch, and

wherein the control unit is configured to, during execution of the voltage-controlled oscillator optimization, switch subbands, which are an oscillation frequency range of the voltage-controlled oscillator that cover a single connection state of the switch, by changing the on/off state with the voltage-controlled tuning capacitor by the switch in a state in which a control voltage applied to the voltage-controlled tuning capacitor is fixed at a predetermined value.

(5) The receiving apparatus according to (4),

wherein the local oscillator is configured as a PLL circuit, and

wherein the control unit is configured to cause the voltage-controlled oscillator to oscillate in a state in which the subband has been switched, and when a difference between the oscillation frequency of the voltage-controlled oscillator and a predetermined reception frequency is within a predetermined range, start feedback control of the PLL circuit at the subband.

(6) The receiving apparatus according to any one of (1) to (5),

wherein the voltage-controlled oscillator optimization is executed when output of the reception signal is performed by another high-frequency processing unit to which a high-frequency signal divided by the divider is input.

(7) The receiving apparatus according to any one of (1) to (6), wherein the control unit is configured to perform control to suppress an oscillation current of the voltage-controlled oscillator during execution of the voltage-controlled oscillator optimization.
(8) The receiving apparatus according to any one of (1) to (7), further including:

a low-noise amplifier configured to amplify the high-frequency signal divided by the divider; and

a through circuit configured to switch a connection state between the low-noise amplifier and respective units that are connected subsequent to the low-noise amplifier,

wherein the control unit is configured to perform control to turn on the low-noise amplifier by opening the through circuit during execution of the voltage-controlled oscillator optimization.

(9) The receiving apparatus according to any one of (1) to (8), further including:

a demodulating unit configured to perform error correction on a reception signal output from the high-frequency processing unit and demodulate a reception signal,

wherein a frequency of an internal clock that has been sped up during execution of the voltage-controlled oscillator optimization is determined based on an error correction processing time at the demodulating unit.

(10) The receiving apparatus according to any one of (4) to (9), wherein the frequency of the clock that has been sped up during execution of the voltage-controlled oscillator optimization is set at a value so that, in a state in which the on/off state of the switch connected to the tuning capacitor has been fixed to a predetermined state, a time during which the magnitude of the oscillation frequency of the voltage-controlled oscillator is compared with the magnitude of the reception frequency is shorter than the error correction processing time.
(11) A receiving method including:

dividing a high-frequency signal received by an antenna;

outputting a reception signal obtained by mixing the divided high-frequency signal and a local oscillation frequency generated by a local oscillator that includes a voltage-controlled oscillator;

increasing a clock frequency speed when executing optimization for searching for a relationship between a control voltage applied to the voltage-controlled oscillator and a local oscillation frequency of the voltage-controlled oscillator.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A receiving apparatus comprising:
at least one divider configured to divide a high-frequency signal received by an antenna;
a high-frequency processing unit configured to output a reception signal obtained by mixing the high-frequency signal divided by the divider and a local oscillation frequency generated by a local oscillator that includes a voltage-controlled oscillator; and
a control unit configured to execute voltage-controlled oscillator optimization for searching for a relationship between a control voltage applied to the voltage-controlled oscillator and a local oscillation frequency of the voltage-controlled oscillator, and increase a clock frequency speed when executing the optimization of the voltage-controlled oscillator.

2. The receiving apparatus according to claim 1, wherein a frequency selection element in the voltage-controlled oscillator comprises a variable capacitance element.

3. The receiving apparatus according to claim 2,
wherein the frequency selection element is configured from a plurality of tuning capacitors, a voltage-controlled tuning capacitor, and a tuning inductor, and
wherein the plurality of tuning capacitors and the voltage-controlled tuning capacitor are connected to each other in parallel.

4. The receiving apparatus according to claim 3,
wherein the plurality of tuning capacitors are switched on and off by a switch, and
wherein the control unit is configured to, during execution of the voltage-controlled oscillator optimization, switch subbands, which are an oscillation frequency range of the voltage-controlled oscillator that cover a single connection state of the switch, by changing the on/off state of the switch in a state in which a control voltage applied to the voltage-controlled tuning capacitor is fixed at a predetermined value.

5. The receiving apparatus according to claim 4,
wherein the local oscillator is configured as a PLL circuit, and
wherein the control unit is configured to cause the voltage-controlled oscillator to oscillate in a state in which the subband has been switched, and when a difference between the oscillation frequency of the voltage-controlled oscillator and a predetermined reception frequency is within a predetermined range, start feedback control of the PLL circuit at the subband.

6. The receiving apparatus according to claim 5,
wherein the voltage-controlled oscillator optimization is executed when output of the reception signal is performed by another high-frequency processing unit to which a high-frequency signal divided by the divider is input.

7. The receiving apparatus according to claim 6, wherein the control unit is configured to perform control to suppress an oscillation current of the voltage-controlled oscillator during execution of the voltage-controlled oscillator optimization.

8. The receiving apparatus according to claim 6, further comprising:
a low-noise amplifier configured to amplify the high-frequency signal divided by the divider; and
a through circuit configured to switch a connection state between the low-noise amplifier and respective units that are connected subsequent to the low-noise amplifier,
wherein the control unit is configured to perform control to turn on the low-noise amplifier by opening the through circuit during execution of the voltage-controlled oscillator optimization.

9. The receiving apparatus according to claim 6, further comprising:
a demodulating unit configured to perform error correction on a reception signal output from the high-frequency processing unit and demodulate a reception signal,
wherein a frequency of an internal clock that has been sped up during execution of the voltage-controlled oscillator optimization is determined based on an error correction processing time at the demodulating unit.

10. The receiving apparatus according to claim 9, wherein the frequency of the clock that has been sped up during execution of the voltage-controlled oscillator optimization is set at a value so that, in a state in which the on/off state of the switch connected to the tuning capacitor has been fixed to a predetermined state, a time during which the magnitude of the oscillation frequency of the voltage-controlled oscillator is compared with the magnitude of the reception frequency is shorter than the error correction processing time.

11. A receiving method comprising:
dividing a high-frequency signal received by an antenna;
outputting a reception signal obtained by mixing the divided high-frequency signal and a local oscillation frequency generated by a local oscillator that includes a voltage-controlled oscillator;
increasing a clock frequency speed when executing voltage-controlled oscillator optimization for searching for a relationship between a control voltage applied to the voltage-controlled oscillator and a local oscillation frequency of the voltage-controlled oscillator.
